(19) United States
(12) Patent Application Publication
(10) Pub. No.: US 2002/0116320 A1
(43) Pub. Date: Aug. 22, 2002

(54) Real-time competitive method of auction using an auctioneer

(76) Inventor: Nicholas Nassiri, Inglewood, CA (US)

Correspondence Address: Nicholas N. Nassiri, 11222 S. La Cienega Blvd, #150, Inglewood, CA, 90304, US

(21) Appl. No.: 10/132,970

(22) Filed: Apr. 26, 2002

Related U.S. Application Data
(63) Continuation-in-part of application No. 09/715,768, filed on Nov. 15, 2000.

(51) Int. Cl. G06F 17/60

(52) U.S. Cl. 705/37

(57) ABSTRACT

The present inventive device provides a new method of interactive, competitive, rapid-fire, on-line auction using an auctioneer. To this end, the present invention generally is comprised of a computer network; the internet; an auction; an auctioneer; real-time, live-stream streaming processes and devices; video, visual, audio, text, biometric and electronic data; an auction input device; and an auction output device.

### BACKGROUND OF THE INVENTION

1. Field of the Invention

The present invention relates generally to the field of on-line auctions using a computer network, and more specifically it relates to a real-time, interactive, method of auction using an auctioneer.

2. Copyright Notice

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

3. Description of the Prior Art

It can be appreciated that various methods of auction have been in use for years. Auctions conventionally took the form of a physical gathering of participants assembled together within a specified location, where the goods to be auctioned resided. Prompted by an auctioneer, bidding is conducted simultaneously, successively and competitively among a group of participants. The presence, participation, and personality of an auctioneer is an essential component: the auctioneer is responsible for instigating bids and increasing the bid amount. The threat of immediate, rapid-fire, constant competition from other participants is a key factor in the auction's excitement and in the ability of the auctioneer to drive up the current bid. Thus, in the traditional form of open auction, the threat of immediate, rapid-fire, constant competition and offering of goods by an auctioneer, are essential.

The advent of electronic commerce, the internet, and its related technologies, dramatically and profoundly changed the nature and the method of the traditional open auction. The internet and its related technologies have liberated the bidder from being physically present at the auction, thereby saving vast amounts of time, expense and travel. Likewise, the corollary is that the internet and its related technologies permit the auction of goods from locations that are geographically remote from the bidders. To state the obvious: the internet has been instrumental in forging a new electronic marketplace that allows buyers and bidders to unite without regard to the constraints of geographical boundaries.

Various methods of “on-line” auctions have flourished via the internet, and are becoming increasingly common place. The prior art discloses several methods of auction, as follow below.

1. The prior art discloses letters U.S. Pat. No. 5,835, 896, issued to Fischer, et al whereby a system for conducting a multi-person, internet-based auction without the use of an auctioneer is depicted. The Fisher auction is a software-based application that allows a group of bidders to place bids over a computer or communications network without using an auctioneer. The bids are recorded by the system of the network and the bidders are updated with the current auction status information via electronic mail. The winner is also notified via e-mail. The Fisher method of auction does not comprise an actual auctioneer, per the method of a traditional auction, nor does it disclose a real-time, competitive, rapid-fire exchange of bids among the auction participants, per the method of a traditional auction.

2. The prior art further discloses Fujisaki U.S. Pat. No. 4,789,928 that describes an auction transmission information processing system. Several computers are linked by telephone lines and arranged in a hierarchical structure. The dealer and front computers transmit bid signals from auction participants through several layers of front computers to the host. The system is not capable of accepting products for sale in real-time. Additionally, the Fujisaki method describes an auction where one seller at a time markets to many buyers, and only one transaction may be completed at a time. The Fujisaki method of auction does not comprise an actual auctioneer, per the method of a traditional auction, nor does it disclose a real-time, competitive, rapid-fire exchange of bids among the auction participants, per the method of a traditional auction.

3. The prior art further discloses Barzilai U.S. Pat. No. 6,012,045 whereby a computer-based method of selling consumer products and consumer services is disclosed. The Barzilai patent utilizes a computer system and a plurality of customer computers interconnected with the computer system via a telecommunications link. The computer system electronically establishes a virtual “electronic showroom” that electronically displays goods and services offered for sale. The computer-based method electronically posts all bids made during the bid period and then the computer accepts the highest bid while excluding bids greater than the lowest high bid from a single bidder. The bidder participates via electronic mail and the winner is notified via electronic mail. The Barzilai method of auction does not comprise an actual auctioneer, per the method of a traditional auction, nor does it disclose a real-time, competitive, rapid-fire exchange of bids among the auction participants, per the method of a traditional auction.

4. The prior art further discloses Harrington, et al U.S. Pat. No. 6,161,099 whereby a computer-based method of auctioning financial documents is depicted. The Harrington patent is depicted as an apparatus and process for conducting municipal bond auctions, over an electronic networks. The auction maintains a web site from which information about bonds to be auctioned can be obtained. A user participates in the auction by accessing the web site via a conventional internet browser and is led through a sequence of screens that perform the functions of verifying the user's identity, assisting the user in preparing a bid, verifying that the bid conforms to the rules of the auction, displaying to the user during the course of the auction selected bid information regarding bids received and informing the bidder how much time remains in the auction. The user may be given the option of confirming the accuracy of his bid before submitting the bid. The auction is able to review bidding history, determine the winner and notify the winner over the network, and display selected auction results to bidders and observers over the network. The Harrington method of auction does not comprise an actual auctioneer, per the method of a traditional auction, nor does it disclose a real-time, competitive, rapid-fire exchange of bids among the auction participants, per the method of a traditional auction.

5. The prior art further discloses Ausabel U.S. Pat. No. 6,021,398 whereby a computer-based method of auctioning is depicted using an auctioneer's system and a database driven computer network. The Ausabel auction includes a number of queries and answers, queries from the auctioneer's system to the database, and answers to the queries from the database. The auctioneer's system is capable of making a decision based on the answers from the database for determining whether an auction should continue. If a decision is reached indicating that the auction should continue, at least one message is generated and communicated to a user system carrying that information. If a decision is reached to terminate or not to continue the auction, then a final message is generated to at least one user system. The final message may include the results of the auction. The Ausabel method of auction does not comprise an actual auctioneer, per the method of a traditional auction, nor does it disclose a real-time, competitive, rapid-fire exchange of bids among the auction participants, per the method of a traditional auction.

The synopsis being that the above referenced prior art methods of on-line auctions are not conducted by an auctioneer who urges the auction participants to bid simultaneously and competitively on an item. Rather, existing on-line auction systems operate by sellers posting their goods for sale (typically using graphical and/or textual information to describe the good), and posting a predetermined period of time whereby prospective buyers may post a corresponding bid for a listed good; said buyer hoping to prevail at the end of the day, or week, or month.

Likewise, the above referenced prior art methods primarily use electronic messaging as the means to tender and facilitate the auction process. Auction participants tender their bids via electronic mail; the “auctioneer”, essentially a database, reads the electronic mail bids and enters them in a database of bids. When the auction closes, the “auctioneer” notifies the winning bidders, via electronic mail of the final results. There exist serious lapses of time and interaction in the foregoing electronic mail based methods. Email can take hours it is routed back and forth between the bidders and the auctioneer, and it may take hours to update bidders as to the current price and availability of the particular item or good. Such methods are not an auction in the true sense of the word, but rather an electronic method of obtaining a maximum price for a good through a predetermined period of time.

In the traditional form of open auction, the real-time is offering of goods by an auctioneer and the competitive, rapid-fire, interaction of participants are essential. While the prior art provides a useful and unique method of on-line auction, it nonetheless fails to provide the excitement and rapid-fire exchange of the traditional open auction. The present inventive device replicates the traditional open auction in two key respects: (i) the present inventive device utilizes an actual auctioneer, and (ii) the present inventive device facilitates interactive, rapid-fire, competitive bidding among the auction participants. The present inventive device seeks to replicate the excitement and the interaction of simultaneous bidding of the traditional auction in the electronic marketplace.

The main problem with conventional methods of on-line auctions is that none of the forgoing methods replicate the traditional method of open auction whereby an auctioneer solicits bids from a plurality of participants who in turn bid openly, competitively, simultaneously, and successively among one another.

Another problem with conventional methods of on-line auctions is that they are not truly “live” auctions though many proffer to be. Rather, the foregoing prior art illustrates a series of exchanged electronic messages that occur over time as opposed to an open auction whereby a auctioneer solicits bids from a plurality of participants who in turn bid openly, competitively, simultaneously, an successively among one another.

Another problem with conventional methods of on-line auctions is that they lack the excitement and competition of the traditional method of auction. Participants interact with electronically generated images and numbers, not an auctioneer per say.

Another problem with conventional methods of on-line auctions is that they are complex and time consuming to use. One must cross-link between multiple web sites and pages in order to locate a particular item or good and continually repeat this process to remain fully apprised of the status of their bid.

In view of the foregoing disadvantages inherent in the known types of on-line auctions now present in the prior art, the present invention provides a new method of on-line auction using a virtual electronic auctioneer. While the devices created by the prior art may be suitable for the particular purpose to which they address, they are not as suitable for conducting an on-line auction using a virtual electronic auctioneer for a true method of interactive, competitive, rapid-fire auction. In this respect, the method of on-line auction according to the present invention substantially departs from the conventional concepts and designs of the prior art, and in so doing provides an apparatus primarily developed for the purpose of conducting an on-line auction using a virtual electronic auctioneer for a true method of interactive, competitive, rapid-fire auction.

### SUMMARY OF THE INVENTION

The general purpose of the present invention, which will be described subsequently in greater detail, is to provide a new method of on-line auction that has many of the advantages of the methods of on-line auction mentioned heretofore and many novel features that result in a new interactive, competitive, rapid-fire method of auction using an auctioneer that is not anticipated, rendered obvious, suggested, or even implied by any of the prior art, either alone or in any combination thereof.

To this end, the present invention generally is comprised of a computer network; the internet; connectivity; an auction; an auctioneer; real-time, live-stream streaming processes and devices; video, visual, audio, text, biometric and electronic data; an auction input device; and an auction output device that collectively structure, facilitate and manage the transactions contemplated herein. The web server structures and manages the functions and processes of website of the present invention.

The computer network is comprised of a host computer and a plurality of remote computers that interact with the host computer and a plurality of servers. The computer network is the means by which the competitive, interactive, rapid-fire on-line auction shall be broadcast via the internet, or other means of connectivity. In the preferred embodiment, the present invention operates a website that provides information regarding the auction and the means by which the auction participant shall be granted access to the auction. The auction participant must first register to qualify as an auction participant through the website, and upon qualifying, the auction participant shall be granted access to participate in the competitive, interactive, rapid-fire on-line auction. Upon a successful registration, a real-time, on-line auction broadcast is established by the host computer server with the participants' remote computers by means of the processes and methods described herein.

The website serves as the point of entrance to the on-line auction, and as a source of information for the on-line auction participant. Participants may access information regarding how to register and utilize the present inventive device. Information further comprises the time, manner and rules of future on-line auctions, and an electronic catalogue of the goods and/or services that will be put up for auction at the respective time and date. The electronic catalogue shall provide the on-line auction participant with visual, audio, textual and graphical data describing a particular good or service available for auction. By way of example, the electronic catalogue may comprise a streaming video clip of a piece of property for sale that presents visual, audio and textual information about the good to the prospective auction participant. Alternatively, the electronic catalogue may comprise a series of TGP's and corresponding textual information for lower end auction items, such as clothing or accessories.

The host computer comprises a database that further comprises the goods and/or services available for auction, as depicted in the electronic catalogue. The goods and/or services are accumulated from a variety of sources, and may be in a location remote from the host computer server, the source of the electronic auction. The goods and/or services available for auction may be located in remote cities and countries but available to any auction participant at any location.

The electronic on-line auction itself is a real-time event that is a creation of the host computer. The electronic auction is broadcast via the host computer to the remote plurality of computers. Upon the auction participant qualifying, the participant may “enter” the interactive, competitive, rapid-fire on-line auction, at any time during the auction event broadcast. The auction broadcast shall have a definite start time and a close time. Per the traditional method of open auction, the length of the interactive, competitive, on-line auction shall be a relatively short span, as measured by hours (as opposed to the static posting of goods over a length of time).

The auction utilizes an auctioneer that offers the items available for auction to the remote plurality of computers. In the preferred embodiment, the inventive device uses an “electronic auctioneer”, said electronic auctioneer is the electronic equivalent of a real-life human auctioneer. The electronic auctioneer utilizes the mannerisms and protocol of the traditional auctioneer; whereby the electronic auctioneer acts as a catalyst to promote the item for auction, by soliciting bids with the intent of obtaining the highest possible price. In the preferred embodiment of the present invention, the electronic auctioneer will be an animated individual who calls out to the auction participants, cajoling the participants to bid for a particular auction item. Likewise, in the preferred embodiment of the present invention, the electronic auctioneer will extol the virtues of the item available for auction, in an attempt to solicit a higher good price.

The present invention further envisions not a single electronic auctioneer type, but several electronic auctioneer types; each with a distinct personality and distinct characteristics. By way of analogy: such as an animated cartoon show with a host of characters like the “Flintstones”, whereby there exist a cast of characters: Barney, Fred, Wilma and Betty, each of whom would present a different separate, animated auctioneer “type”.

The present inventive device envisions that auction participants will come to relate, or associate with, the personality and peculiarities associated with an individual electronic auctioneer “type”; much in the way one has a favorite animated cartoon character or celebrity with whom they watch or admire. The website of the inventive device shall contain biographical data on each electronic auctioneer, such as the town in which they were born (Bedrock), likes, dislikes, and so on. The present invention shall offer “participant-item auctions” whereby participants may choose to auction personal services or goods, using the electronic auctioneer of choice, who shall auction the participants' services or goods.

In the preferred embodiment of the present invention, the electronic auctioneer is programmed to recognize registered bidders participating in the auction by way of information from the host computer. The electronic auctioneer is programmed to address said participants directly in the form of solicitation, such as, “John Doe, open up that wallet and bid!” The objectives of the electronic auctioneer soliciting or cajoling the participants, are to increase the bid price, and to add excitement, exhilaration of live auction, and humor to the auction by direct participation with its audience.

In an alternative embodiment of the present invention, the auction utilizes a real-life, human being auctioneer who offers the items available for auction to the remote plurality of computers from a location that is remote from where the goods are physically located. To state the obvious: the human auctioneer utilizes the mannerisms and protocol of the traditional auctioneer; whereby the human auctioneer acts as a catalyst to promote the item for auction, by soliciting bids with the intent of obtaining the highest possible price. As per the preferred embodiment of the present invention, the human auctioneer will be a gregarious individual who calls out to the auction participants, cajoling the participants to bid for a particular auction item. Likewise, per the preferred embodiment of the present invention, the human auctioneer will extol the virtues of the item available for auction, in an attempt to solicit a higher good price.

The present invention further envisions not a single human auctioneer type, but several auctioneer types; each with a distinct personality and distinct characteristics. The present inventive device envisions that auction participants will come to relate, or associate with, the personality and peculiarities associated with an individual human auctioneer “type”; much in the way one has a favorite celebrity with whom they watch or admire. The website of the inventive device shall contain biographical data on each human auctioneer, such as the town in which they were born, likes, dislikes, and so on. The present invention shall offer “participant-item auctions” whereby participants may choose to auction personal services or goods, using the human auctioneer of choice, who shall auction the participants' services or goods.

Per the preferred embodiment of the present invention, the human auctioneer is able to recognize registered bidders participating in the auction by way of information from the host computer. The human auctioneer will use this information to address said participants directly in the form of solicitation, such as, “John Doe, open up that wallet and bid!” The objectives of the human auctioneer soliciting or cajoling the participants, are to increase the bid price, and to add excitement and humor to the auction by direct participation with its audience.

In either embodiment, as the auctioneer is auctioning a particular service or good, the auction participant shall view the item available for auction in conjunction with the auctioneer. The item available for auction may be presented in a variety of formats, including, but not limited to, a presentation of audio, visual, electronic, or textual data, either singularly or in conjunction with one another. By way of example, the browser of the remote computer would depict: the electronic auctioneer vigorously auctioning a good, an audio feed of the electronic auctioneer's voice, a graphical image of the good currently up for auction, and textual information of the good. The browser will further depict information necessary for participants to bid competitively: the minimum start price, the current bid amount, the user identity correlated with the highest prevailing bid.

In the preferred embodiment, the auction participant may manipulate the presentation of the auction item, by selecting a different presentation request (such as a side view or 3-D view), or alternatively, inputting a different presentation request from the remote computer system.

The auction participant views the interactive, competitive, rapid-fire auction from the remote computer device, and in response to solicitations from the auctioneer, bids competitively, successively and simultaneously on the item available for auction at that particular point in time. To replicate the excitement and competitiveness of the traditional live open auction, the ability to tender bids on a real-time basis is essential for the electronic auction. To this end, the present invention further comprises an “auction input device” (AID) that enables the electronic auction participant to submit a rapid-fire bid, real-time to the host computer, which in turn submits the bid to electronic auction. The auction input device may be a function of the remote computer system or a device remote from it.

The host computer system further comprises a bid mechanic verification module that functions to receive, rank, and process and validate the simultaneous and successive bids of the interactive auction participants. The host computer conveys the validated bid information to the auctioneer. The auctioneer in turn orally conveys the updated bid information to the plurality of remote computers, and attempts to solicit a higher bid. Simultaneously, the browser of the remote computer system shall depict the current bid price and corresponding bidder identity as textual or graphical information. Upon cessation of bidding, the auctioneer determines the winner according to the most recent, highest bid received and notifies the plurality of remote computers on the status thereof. The results of the electronic auction are broadcast to the plurality of remote computers.

There has thus been outlined, rather broadly, the more important features of the invention in order that the detailed description thereof may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a interactive, rapid-fire, competitive method of electronic auction that utilizes an electronic auctioneer to solicit bids from the plurality of remote computers with the intent of obtaining the highest possible bid.

A primary object of the present invention is to provide a interactive, rapid-fire, competitive method of electronic auction that utilizes a human auctioneer to solicit bids from the plurality of remote computers with the intent of obtaining the highest possible bid.

A primary object of the present invention is to provide a interactive, rapid-fire, competitive method of electronic auction wherein auction participants bid individually, competitively, successively, and simultaneously against one another utilizing a real-time method of input and exchange.

A further object of the present invention is to provide a interactive, rapid-fire, competitive method of electronic auction that replicates the method and protocol of the traditional open auction.

A further object of the present invention is to provide a interactive, rapid-fire, competitive method of electronic auction that enables the interactive auction participant to input bids in a rapid-fire, real-time basis.

Another object of the present invention is to provide a interactive, rapid-fire, competitive method of electronic auction that unites geographically diverse parties to a central electronic auction event.

Another object of the present invention is to provide a interactive, rapid-fire, competitive method of electronic auction that provides consumers and businesses with expanded markets and profits through increased auction participation and market penetration.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRITPION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart that illustrates the overall process of the method of the present invention.

FIG. 2 is a flowchart that illustrates the overall process of registering to participate in the live interactive method of auction and qualifying to participate in the live interactive method of auction.

FIG. 2A is a flowchart that illustrates the overall process of using and submitting an absentee bid record to the Absentee Bid Agent.

FIG. 3 is a flowchart that illustrates the overall process of the plurality of remote computers submitting bids to the live interactive method of auction and determining the auction winner.

FIG. 3A is a flowchart that illustrates the process of validating bids submitted to the live interactive method of auction from the plurality of remote computers.

FIG. 3B is a flowchart that illustrates the process of the absentee bid agent submitting bids to the live interactive method of auction.

FIG. 4 is a flowchart that illustrates the information that is simultaneously broadcast from the host web server to the plurality of remote computers.

### DETAILED DESCRIPTION OF THE PREFERRED EMBODIMENT

### I. Description of How the Present Invention Works

Turning now descriptively to the drawings, in which similar reference characters denote similar elements throughout the several views, the attached figures illustrate a interactive, rapid-fire, competitive method of electronic auction, which comprises a computer network; the internet; an auction; an auctioneer; real-time, live-stream streaming processes and devices; video, visual, audio, text, biometric and electronic data; an auction input device; and an auction output device. Collectively, these devices and processes function to broadcast real-time the electronic auction to a group of participants that are geographically dispersed.

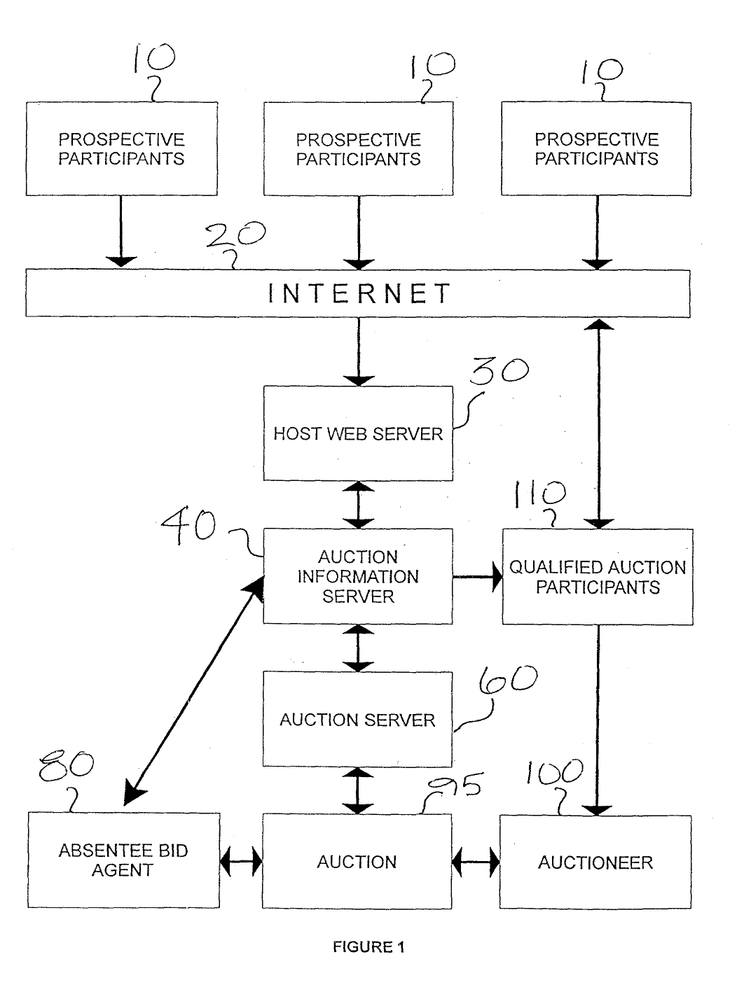

FIG. 1 denotes the computer network, the computer network is the foundation by which the electronic auction 95 shall be broadcast real-time via the internet 20 to the plurality of remote computers 10. The computer network is comprised of a host web server 30, an auction information server 40, an auction server 60, a absentee bidder agent 80 and a plurality of remote computers 10 that are connected to the host web server 30 through communication lines. The web host server 30 initiates, structures and manages the relationships between the computer network and the remote plurality of computers 10. The computer network protocol servers cooperate with separate database computers, and the database computers are accessible to at least one of the hypertext transport protocol servers to allow for the retrieval of information.

The web host server 30 commences the real-time stream of electronic data transfer between the parties to the electronic auction. Connectivity between the plurality of remote computers 10 and the web host server 30 is comprised of telecommunications, satellite communications, broadband communications and other means of communication utilized to access the internet 20.

The broadcast is further comprised of devices and processes that serve to simultaneously transmit electronic data between the parties to the auction 95. Electronic data comprises audio, video, visual, text, and biometric data exchange between the host web server 30 and the plurality of remote computers 10. The exchange is reciprocal; that is, the host web server 30 has the ability to transmit the varied electronic data to the plurality of remote computers 10 and the plurality of remote computers 10 has the ability to transmit electronic data to the host web server 30. The plurality of remote computers 10 shall not transmit electronic data amongst themselves; however, the host web server 30 shall transmit electronic data from any one of the plurality of remote computers 10 to all of the plurality of remote computers 10.

The plurality of remote computers' 10 configuration is comprised of connectivity with the host web server 30; a browser of the remote computer system that interfaces with the host web server 30 via the internet 20; an auction output device; and an auction input device. The output device is a device that visibly displays the auction 95 broadcast to the qualified interactive auction participant 110. The present invention utilizes a variety of output devices, including, but not limited to, a monitor connected to the remote computer, a telephone, a cellular phone, a personal digital assistant (PDA), or other such remote devices used to retrieve information from the internet 20.

The auction 95 comprises an electronic auction event that is broadcast real-time via the host web server 30 and is a function of the host computer 30. The auction 95 comprises a plurality of goods, services, items, securities or commodities available for auction. The auction 95 comprises a fixed start time and end time. The auction 95 utilizes an auctioneer 100 to conduct the auction.

The auction is comprised of goods and services that are remote from the broadcast. In one instance, the goods reside at various warehouses or in various locations and locales, and the auction serves as a vehicle to sell these goods to a global audience that would otherwise be precluded as a potential market.

In another instance, auction serves as a vehicle whereby the participants may submit goods or services for auction. The “participant item” auction serves as a vehicle for auction participants to auction their goods or services to one another using the website and using the auctioneer of their choice. The auction shall serve to facilitate the auctioning of goods, much in the way that Ebay and the like function, with the notable distinction that the present inventive device shall provide the services of an actual auctioneer and a real-time auction broadcast.

The auction participant 110 participates in the auction by way of a site on the world-wide-web 20. The website provides information regarding the auction 95 and the means by which the plurality of remote computer 10 shall register and be granted access to participate in the auction 95. The internet 20 and the website thus serve as a point of entrance to the auction 95 and the means through which the auction 95 is broadcast to the plurality of remote computers 10. Audio, text, visual or video information may be presented to the prospective auction participant 10 from the website.

The website further comprises a schedule of upcoming auctions and a corresponding schedule of the particular goods, services, securities, commodities, or items available for auction; collectively referred to as the auction “items”. Descriptions and images of the items available for auction will be stored in an electronic format and compiled in an electronic catalogue, the equivalent of the auction catalogue, that is viewed via the website or may be downloaded as a file. Prospective auction participants 10 can peruse the electronic catalogue prior to the auction 95. The items for auction will have a reference code or number listed in the electronic catalogue that corresponds to the auction item. The website may be searched by fields, keywords or other search techniques for information regarding the auction itself and for the items available for auction.

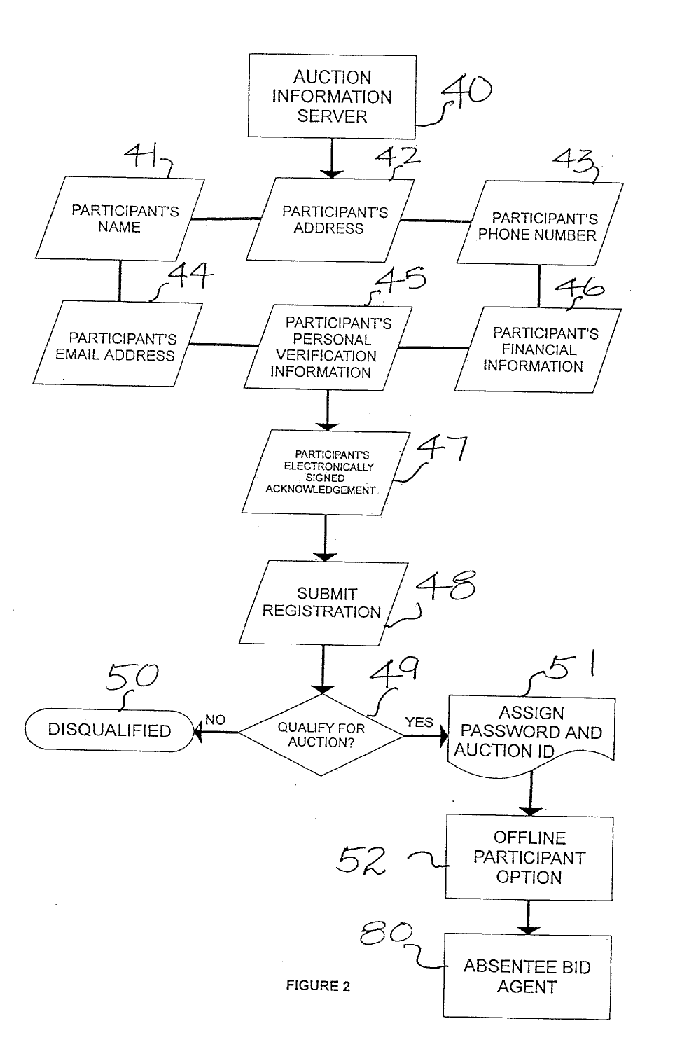

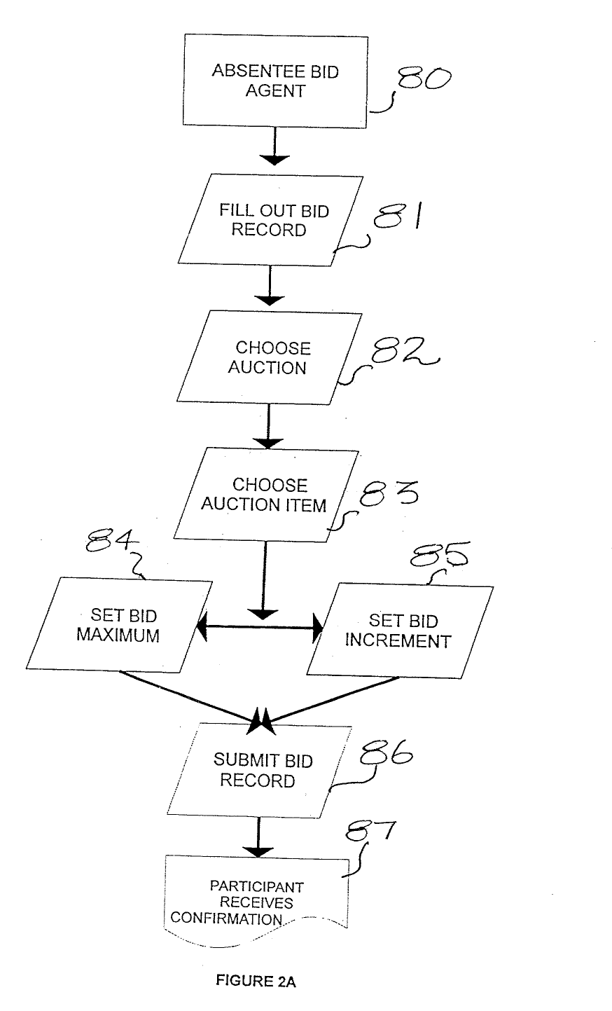

The prospective auction participant 10 must register 48 to participate in the auction of their choice. FIG. 2 denotes the process of registration. Registration 48 may be done prior to the auction or during the auction 95. The prospective participant 10 accesses a registration form on the website and inputs the following information: (a) the registrant's name 41; (b) the registrant's address 42; (c) the registrant's phone number 43; (d) the registrant's electronic mail address 44; (e) the registrant's personal verification information, including, government issued documents, biometric data, and personal information 45; (f) the registrant's qualifying financial information 46; and (g) an electronically signed acknowledgement whereby the registrant agrees to abide by the rules and regulations of the auction 47. The registrant sends the registration form to the host web server 30 via electronic mail 48 from the plurality of remote computers 10. The host web server 30 in turn notifies the registrant of receipt of the electronic mail 48 and the auction information server 40 processes the registration simultaneously 49.

A registrant that fulfills the registration criteria is assigned an identification number or code and a password that corresponds to their registration account 51. The host web server 30 conveys this information to the registrant who may then utilize the password and identification number or code to access the respective auction 95 of their choice 60. A registrant that does not qualify is notified accordingly and denied access to the auction 50.

The website provides the means by which the auction participant 110 directly enters and participates in the auction 60. Several auction choices may be available; upon selecting one, the auction participant 110 enters into a particular auction site 95. At this point in time, host web server 30 establishes a real-time connection between the host web server 30 and the plurality of remote computers 10.

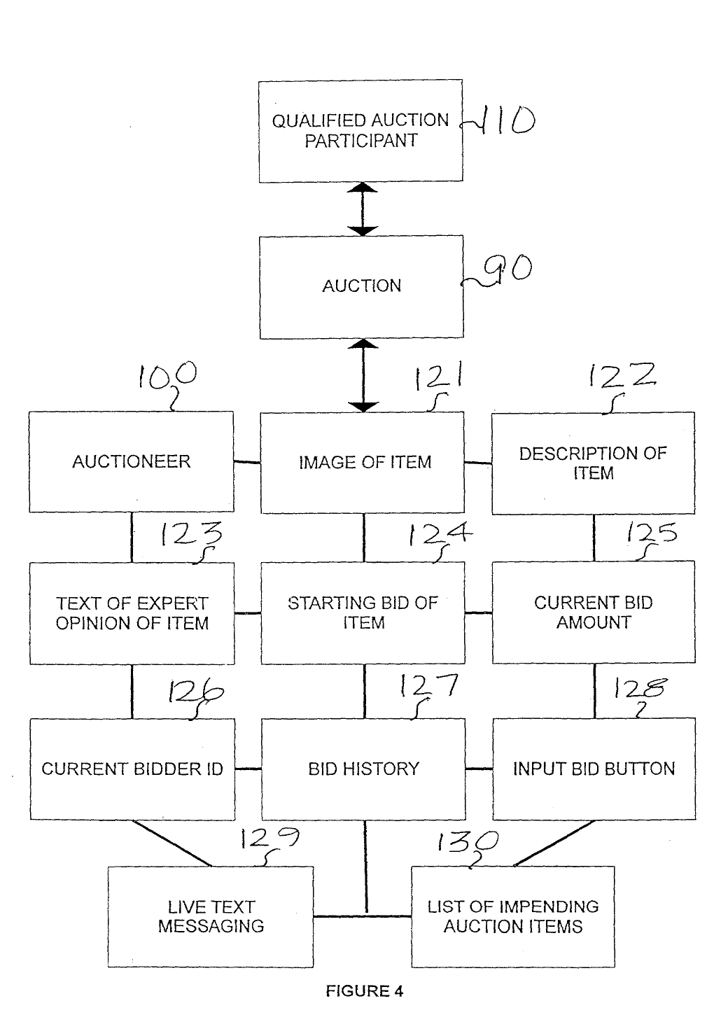

FIG. 4 denotes the information that is simultaneously broadcast to the plurality of remote computers 10 by the host web server 30. The real-time broadcast simultaneously displays the following information to the browser of the interactive auction participant 110: (a) an auctioneer 100 who actively solicits bids from the interactive auction participants 110 per the traditional method of open auction wherein the auctioneer 100 promotes the good offered and attempts to increase the price 120; (b) an electronic image of the particular goods, service, security, commodity, or item available for auction; the image itself may comprise audio, visual, video or text data 121; (c) an electronic description of a particular goods, service, security, commodity, or item available for auction; the description itself may comprise audio, visual, video or text data 122; (d) expert opinion regarding a particular goods, service, security, commodity, or item available for auction, the opinion itself may comprise audio, visual, video or text data 123; (e) the minimum starting bid of a particular goods, service, security, commodity, or item available for auction 124; (f) the current bid amount 125; (g) the current bidder as represented by the identification number 126; (h) the bid history 127; (i) an input bid button by which the interactive auction participant 110 inputs a bid 128; (j) live-text messaging that depicts the current bid and corresponding identification number 129; and (k) a schedule of the upcoming items to be auctioned in the auction at hand 130.

After entering the auction 60, the auction participant 110 participates in a real-time exchange with the auctioneer 100 and with other registered auction participants 110. The registered participant 110, may, however, enter and participate in the auction 95 at any time during the auction 95. As with the traditional form of open action, the bidding for a particular item is opened at some predetermined minimum and bidding is conducted orally by the auctioneer 100. In the preferred embodiment, the electronic auction 95 parallels the process and protocol of the traditional open auction, whereby the auctioneer 100 is the central figure that serves to conduct the auction 95 and drive up the bid amount by interacting with the auction participants.

In the preferred embodiment of the invention, the auction 95 utilizes a virtual electronic auctioneer 100 to conduct the auction. The virtual electronic auctioneer 100 is a software application and a function of the host computer 30. The software application is programmed to create an electronic equivalent of a real-life human auctioneer. The electronic auctioneer 100 is a personification of a traditional auctioneer, embodying the same mannerisms an protocol thereof. The form of the virtual electronic auctioneer 100 simulates the characteristics and personality of a real-life human being, or a caricature thereof, or some other form of animation such as a cartoon character or a variation thereof. By way of example, the electronic auctioneer 100 may be depicted as an animated character bearing a moustache, gavel, vest and hat; much like in the days of old.

Notwithstanding the foregoing, the present invention envisions not a single electronic auctioneer type or caricature, but several electronic auctioneer 100 types or caricatures; each with a distinct personality and characteristics. By way of analogy: consider an animated or cartoon show that typically comprise a host of characters, such as the Flintstones, whereby there exist a cast of characters: Barney, Fred, Wilma and Betty, each of whom would present a separate, animated auctioneer type. The present inventive device envisions that auction participants will come to associate with an individual electronic auctioneer 100 type, much in the way one has a favorite animated cartoon character or show.

In the preferred embodiment of the present invention, the electronic auctioneer 100 is programmed to recognize registered bidders participating in the auction 95, by way of information from the host computer 30. The electronic auctioneer shall address said auction participants directly in the form of solicitation or communication, such as, “John Doe, open up that wallet and bid!”, or some other form of solicitation or communication. The ability of the electronic auctioneer 100 to recognize a particular auction participant 20 is a function of the host computer 30, whereby the host computer 30 culls personal information from the auction participant's registration account (such as a username or first name) and conveys said information to the electronic auctioneer 100. The electronic auctioneer 100, in turn uses such information to increase the level of participation and entertainment of the auction 95.

In another embodiment the electronic auctioneer 100 works in conjunction with another animated personality, perhaps a second animated electronic auctioneer 100, or a animated cartoon or a caricature; each with a distinct personality and characteristics. Irrespective of the electronic auctioneer 100 type, the electronic auctioneer 100 may appear in a variety of formats and mediums, including, but not limited to, audio, visual, textual, graphical or electronic data, or any combination thereof.

In another embodiment of the present invention, the auction 95 utilizes a real-life, human being auctioneer 100. In one instance, the human auctioneer 100 offers for auction 95, or participant item auction models; whereby any of the foregoing parties may contract with the present inventive device to provide an auction 95 broadcast using the real-life auctioneer 100, to the remote plurality of computers 20.

To state the obvious: the human auctioneer 100 utilizes the mannerisms and protocol of the traditional auctioneer; whereby the human auctioneer 100 acts as a catalyst to promote the item for auction, by soliciting bids with the intent of obtaining the highest possible price. As per the preferred embodiment of the present invention, the human auctioneer 100 will be a gregarious individual who calls out to the auction 95 participants 20, cajoling the participants 20 to bid for a particular auction item. Likewise, per the preferred embodiment of the present invention, the human auctioneer 100 will extol the virtues of the item available for auction 95, in an attempt to solicit a higher good price.

The present invention further envisions not a single human auctioneer 100 type, but several human auctioneer types; each with a distinct personality and distinct characteristics. The present inventive device envisions that auction participants will come to relate, or associate with, the personality and peculiarities associated with an individual human auctioneer 100 “type”; much in the way one has a favorite celebrity with whom they watch or admire. The website of the inventive device shall contain biographical data on each human auctioneer 100, such as the town in which they were born, likes, dislikes, and so on. The present invention shall offer the auction services, whereby customers may choose the human auctioneer 100 of choice, who shall auction the customer's services or goods.

Per the preferred embodiment of the present invention, the human auctioneer 100 is able to recognize registered bidders participating in the auction by way of information from the host computer 30. The human auctioneer 100 will use this information to address said participants 110 directly in the form of solicitation, such as, “John Doe, open up that wallet and bid!” The objectives of the human auctioneer 100 soliciting or cajoling the participants 110, are to increase the bid price, and to add excitement and humor to the auction 95 by direct participation with its audience.

Auction participants 110 partake in the auction 95 by way of a local computer system 10 that further comprises an auction output device and an auction input device. In the preferred embodiment, the auction output device comprises a computer that utilizes a screen, typically a monitor, whereby the browser of the local computer system 10 displays the auction 95 in action. Said computer may comprise various forms, such as a desktop, laptop, or PDA. Alternatively, said computer output device may comprise a television or other such device capable of transmitting broadcast signals.

In the preferred embodiment of the present invention, the browser will display the following broadcast: information regarding the particular good, commodity or service available for auction 95 (hereinafter collectively referred to as the “auction item”; said information further comprising: a description of the auction item, a picture of the auction item (said picture may comprise various forms, including but not limited to, a TGP, a video clip, or a live stream broadcast), the minimum start price or reserve price of the auction item, the current bid amount, the current bidder identity, the total amount of bids received, and the auctioneer. In the preferred embodiment, the auction information is displayed simultaneously as a live text posting that is displayed on the browser of the local computer system as a continual, real-time update of the auction information.

Simultaneous to the auction information, the browser of the local computer system 10 shall display the auctioneer 100 in action. In the preferred embodiment, the auctioneer 100 is an animated individual that interacts with the auction participants 110 by way of a visual and audio broadcast, that is further comprised of varied electronic data. That is, auction participants 110 shall see and hear the auctioneer 100 via their browser, in addition to the auction information. As stated above, the auctioneer utilizes the mannerisms and protocol of the traditional auctioneer; whereby the auctioneer 100 acts as a catalyst to promote the item for auction, by soliciting bids with the intent of obtaining the highest possible price.

In response to the auctioneer's (either electronic or human) 100 solicitations, the auction participant 110 bids individually, competitively, successively and simultaneously in conjunction with the other auction participants 110. The auction participant 110 bids by submitting a fixed bid amount 62 submits the bid 62 utilizing an Auction Input Device (AID). Specifically, the auction participant 110 interacts with the host web server 30; i.e. submits a bid 62 to the auction 95, through the AID.

Structurally, the AID may be comprised of a keyboard, a mouse, a remote controlled pointing device, and the like. Functionally, the AID operates in conjunction with the input bid button 128 that may be activated in a variety of ways. In one embodiment of the present invention, the AID consists of the auction participant 110 inputting a code or numbers via the remote computer 10 using a mouse, an electronic capture pad, a remote control or by entering a code or numerical figure with a keyboard.

In another embodiment of the invention, the auction participant 110 inputs a biometric bid such as a signature, voiceprint, handprint, fingerprint or retina information via the remote computer 10 using a mouse, an electronic capture pad, a remote control or by entering a code or numerical figure with a keyboard.

The AID is essential to the functionality of the present invention's objectives: the AID operates to ensure that the rapid-fire competitive bid process of the traditional open auction prevails in the electronic auction 95 equivalent by allowing for the rapid-fire input of the electronic bid 62 to the auction 95.

The auction server 60 updates the bid information 66 as bids from the auction participants 110 supercede one another in amount and time. The auction server 60 determines when electronic data input 62 originating from any one or all of the plurality of remote computers 10 has ceased. Upon the host web server 30 broadcasting the current highest bid 64, the auctioneer 100 interacts with the plurality of remote computers 110 (as described above) with the intent of soliciting a higher bid.

The auctioneer 100 is notified when no more bids are received 67 via the auction server 60. At the point whereby the host computer determines that no bids 62 are received from the plurality of remote computers 10, the auctioneer 100 reacts by way of soliciting more bids 101 and serves to close 102 the auction 95. The auctioneer's 100 step of reacting 101 entails a final attempt by the auctioneer 100 to solicit a higher bid amount from the plurality of remote computers 10, wherein the auctioneer 100 calls out the impending close of the auction 95 to the plurality of remote computers 10. In the preferred embodiment of the present invention, the auctioneer 100 will attempt to solicit more bids per the traditional method of auction; with the auctioneer 100 calling “going once . . . , going twice . . . , sold” or some variation thereof.

If no more bids 62 are received the auctioneer 100 moves to close the auction 102. If the host web server 30 receives additional input bids 62, the auction 95 continues. If the host web server 30 receives no additional input bids 62, the auction 95 closes 102. Again, the auctioneer 100 shall embody the mannerisms and characteristics of a traditional auctioneer by banging a gavel and proclaiming a winner, “sold to John Doe for 1,000.00 dollars! Congratulations Sir!” Upon closing 102, the auctioneer 100 notifies the auction participants 110 of the auction 95 outcome, including the winning bid amount 64 and the corresponding identification number 51. The auction 95 itself continues until each of the particular items, goods, services, securities or commodities available for auction has been auctioned off by way of the methods and processes described herein.

(i) Synopsis of the Operation of the Preferred Embodiment

Described briefly, the method of auction comprising the following steps (a) the auction participant accesses the website on the world-wide-web by way of a remote computer; (b) the remote computer establishes connectivity with the host computer by way of the website; (c) the prospective participant registers to qualify to participate in the auction by way of the website; (d) the host computer qualifies and grants the registrant to participate in the auction; (e) the host computer establishes real-time, connectivity with the remote computer; (f) the host computer simultaneously displays to the plurality of remote computers, a real-time, broadcast that comprises varied electronic data; (g) the remote computers individually, successively and simultaneously input electronic data in response to the broadcast signal from the host computer; (h) the host computer receives, validates and processes in a ranked order the electronic data originating from any of the plurality of remote computers; (i) the host computer simultaneously broadcasts in a ranked order to all of the remote plurality of computers the validated electronic data originating from any one of the plurality of remote computers; (j) the host computer repeats steps “h” and “i” each time the host computer receives electronic data input from any of the plurality of remote computers; (k) the host computer determines when electronic data input originating from any one or all of the plurality of remote computers has ceased; (l) the host computer determines which of the plurality of remote computers sent the most recent validated electronic data input; and (m) the host computer broadcasts to the plurality of remote computers the status of the cessation of the electronic data entry and the results thereof.

### II. Alternative Embodiments of the Present Invention

(i) Participation in the Electronic Auction Using a Proxy

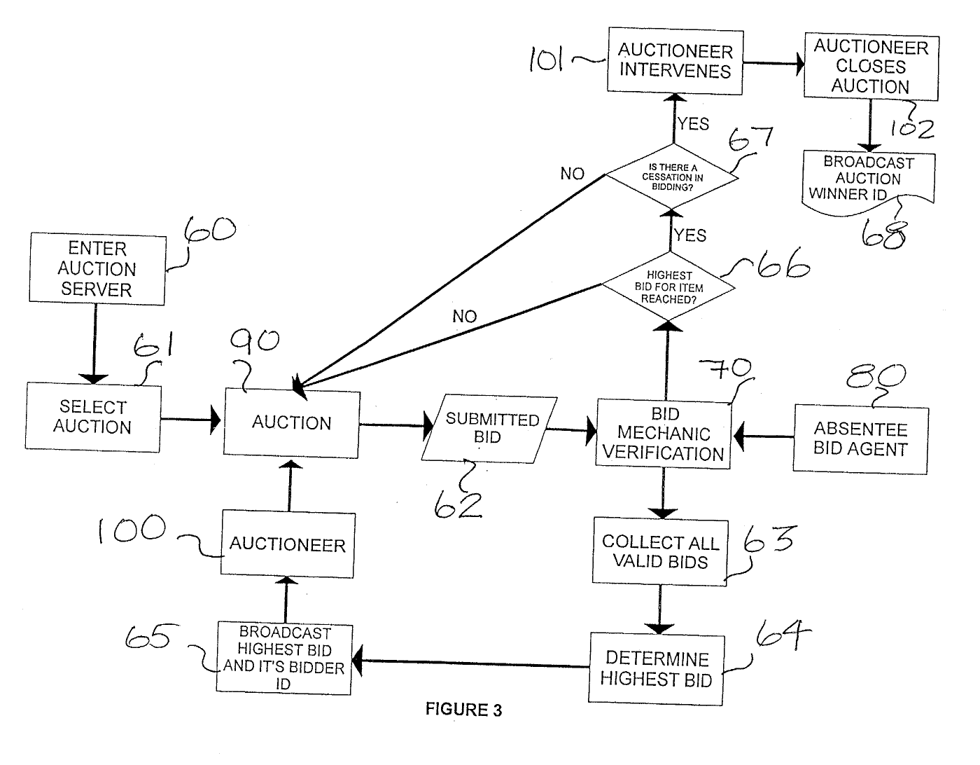

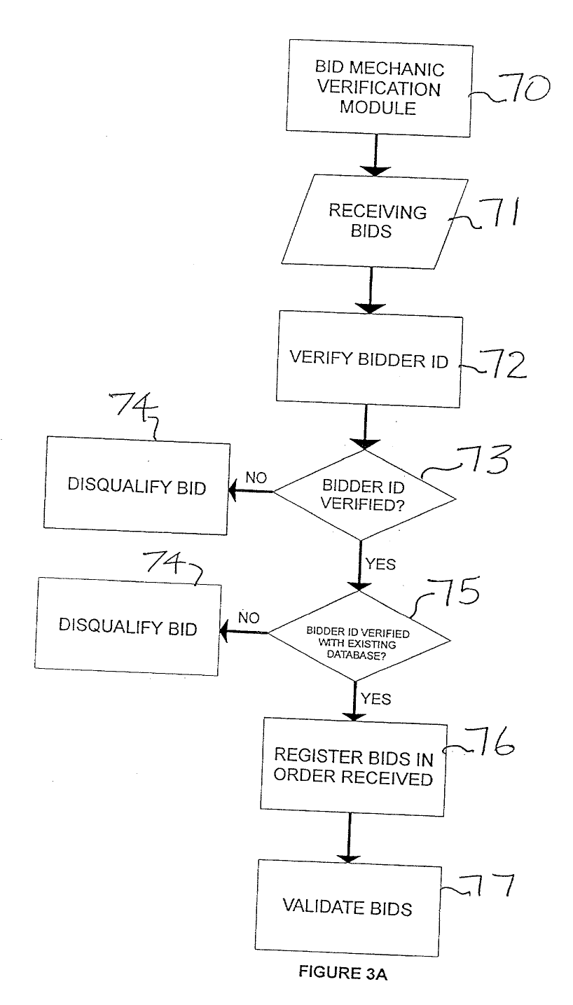

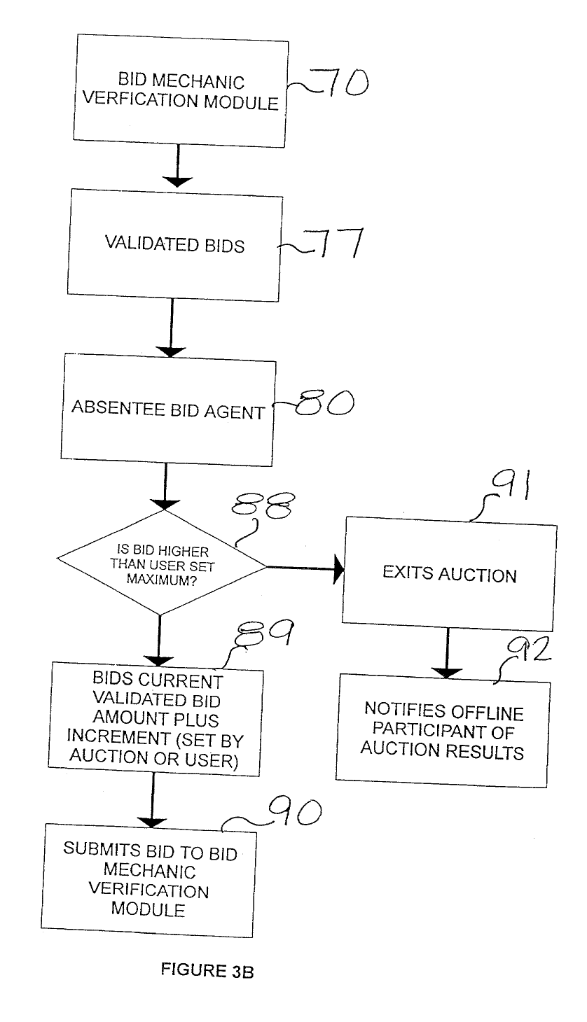

FIG. 3B denotes the mechanics utilized by the Absentee Bid Agent 80. The Absentee Bid Agent 80 (“ABA”) serves to act on behalf of an auction participant 110 when the auction participant 110 is unable or unwilling to participate in the auction 95. The Absentee Bid Agent 80 is an application that submits bids independently to the auction 95 on a real-time basis. The Absentee Bid Agent 80 is subject to the same rules of auction and qualifying criteria as the interactive auction participant 110 who opts to utilize it.

FIG. 2A denotes the process of creating and submitting an absentee bid record. 81 The bid record 81 is created by the auction participant 110 who submits 52 the bid record 81 to the host web server 30 with a request that the Absentee Bid Agent 80 manage the bid record 81 during the auction 95. The bid record 81 comprises the following information: (a) the particular auction 95 the auction participant 110 wishes to participate in 82; (b) the item of auction the participant wishes to bid on 83; (c) the maximum bid amount for the item 84; and (d) the increments by which to reach the maximum bid 85. Increments by which to reach the maximum bid amount 84 may be determined by the rules of the auction or by the auction participant 110. Upon completion of the bid record 81 the auction participant 110 submits the bid record 81 to the host web server 86. Upon receipt of the bid record 81, the host web server 30 sends a confirmation 87 to the remote computer 10.

The Absentee Bid Agent 80 interacts with the Bid Mechanic Verification Module 70. The Absentee Bid Agent 80 competes with validated bids 77 that have outbid 88 the interactive auction participants 110 prevailing bid record 81. If such bids are found 88, the Absentee Bid Agent 80 automatically increases the bid 89 on the interactive auction participant's 110 behalf, up to the maximum bid amount 84 established by the interactive auction participant. The Absentee Bid Agent 80 then submits the bid 90 to the Bid Mechanic Verification Module 70. The Absentee Bid Agent. server 80 bids competitively and successively until the prescribed maximum bid amount 84 has been reached or until the bid record 81 prevails as the winner.

Specifically, the Absentee Bid Agent 80 operates as follows: (a) the Absentee Bid Agent 80 operates separate and independent from the auction server 60; (b) the Absentee Bid Agent 80 determines the prevailing bid amount 88; (c) the Absentee Bid Agent 80 bids the current prevailing bid plus the bid increment amount 89; and (d) submits the absentee bid record 90. The Absentee Bid Agent 80 will automatically outbid other bidders 110 until said maximum bid amount 84 is reached or the bid record prevails as the highest winning bid 64. Upon the cessation of bidding the Absentee Bid Agent 80 automatically exits the auction 91 and notifies the auction participant 110 of the results thereof 92.

(ii) Auction Participants Posting Items for Auction

In another embodiment of the invention, the items available for auction 95 are comprised by submissions of items for auction from the remote plurality of computers 20. In this method of auction, registered participants access the website of the present invention to post an item for auction, in the participant item auction.

The method of posting an item for auction comprising of the following steps: (a) the registered user accesses the website and selects an upcoming “participant-item” auction; (b) the registered user completes and submits an auction item submission form, the submission form in part comprising of a description, electronic image and minimum starting bid of the item for auction (c) the registered user submits the auction item submission form to the central host computer; (d) the host computer confirms receipt of the submission form; (e) the host computer confirms that the item for auction is in compliance with the rules and regulations for auction; (e) the host computer accepts the item for auction and notifies that registered user thereof; (f) the host computer posts the item for auction in the electronic catalogue corresponding to the participant-item auction.

The participant-item auction 95 is a function of the host computer 30. The host computer 30 participant-item auction 95 is a real-time broadcast of auction that utilizes the auctioneer 100 of their choice. Per the method of the preferred embodiment, the participant-item auction 95 constitutes a real-time broadcast, and an interactive, competitive exchange with the plurality of remote computers 20. Per the method of the preferred embodiment, the auction is opened at some predetermined minimum and bidding is conducted orally by the auctioneer 100; the auctioneer 100 solicits bids; the auctioneer 100 and moves to close the participant-item auction 95 upon cessation of bidding; and the auctioneer 100 declares a winner.

Described briefly, the method of participant-item auction comprising the following steps: (a) the interactive auction participant accesses the website on the world-wide-web by way of a remote computer; (b) the remote computer establishes connectivity with the host computer by way of the website; (c) the prospective participant registers to qualify to participate in the auction by way of the website; (d) the host computer qualifies and grants the registrant to participate in the auction; (e) the host computer establishes real-time, live-stream connectivity with the remote computer; (f) the host computer substantially simultaneously displays to the plurality of remote computers, a real-time, broadcast signal that comprises varied electronic data; g) the remote computers individually, successively and simultaneously input electronic data in response to the broadcast signal from the host computer; (h) the host computer receives, validates and processes in a ranked order the electronic data originating from any of the plurality of remote computers; (i) the host computer simultaneously broadcasts in a ranked order to all of the remote plurality of computers the validated electronic data originating from any one of the plurality of remote computers; (j) the host computer repeats steps “h” and “i” each time the host computer receives electronic data input from any of the plurality of remote computers; (k) the host computer determines when electronic data input originating from any one or all of the plurality of remote computers has ceased; (l) the host computer determines which of the plurality of remote computers sent the most recent validated electronic data input; and (m) the host computer broadcasts to the plurality of remote computers the status of the cessation of the electronic data entry and the results thereof.

### III. Conclusions, Scope, and Ramifications of the Present Invention

Existing methods of on-line auctions are not truly “open” auctions, in the traditional sense, though many of them proffer to be. The fault with existing methods of on-line auctions is that none of the existing methods replicate the atmosphere of an open auction whereby an auctioneer solicits bids from a plurality of participants who in turn bid openly, competitively, simultaneously, and successively among one another real-time.

In view of the foregoing disadvantage inherent in the known types of on-line auctions, the present invention provides a on-line method of auction, using an auctioneer, whereby a plurality of participants bid openly, competitively, simultaneously, and successively among one another. In this respect, the method of auction according to the present invention substantially departs from the conventional concepts and designs of the prior art, and in so doing provides an apparatus primarily developed for the purpose of conducting an on-line real-time method of auction, using an auctioneer, whereby a plurality of participants bid openly, competitively, simultaneously, and successively among one another.

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A method of conducting an electronic auction utilizing a remote broadcast location, a computer network; said computer network comprising a host web server, an auction information server, an auction server, an auctioneer and a plurality of remote computers and communication lines connecting said remote computers to said computer network and to said remote broadcast location; said method of auction comprising of the following steps:
said plurality of remote computers access a website on the world wide web;
said plurality of remote computers establish connectivity with said host web server by way of said website;
said plurality of remote computers register to qualify to participate in said method of auction by way of said website;
said host web server qualifies and grants said plurality of remote computers access to participate in said method of auction;
said host web server establishes real-time connectivity with said remote broadcast location and with said plurality of remote computers;
said host web server substantially simultaneously displays to said plurality of remote computers, real-time, live-stream broadcast signals;
said broadcast signals comprise varied electronic data;
said plurality of remote computers individually, successively and simultaneously input electronic data in response to said broadcast signals from said host web server;
said auction server receives, validates and processes in a ranked order said electronic data originating from said plurality of remote computers;
said host web server simultaneously broadcasts real-time in a ranked order to all of said plurality of remote computers
said electronic data originating from any one of said plurality of remote computers;
said host web server repeats steps “i” and “j” each time said host web server receives said electronic data from any of said plurality of remote computers;
said host web server determines when said electronic data originating from any one or all of said plurality of remote computers has ceased;
said auction server determines which of said plurality of remote computers sent the most recent submission of said electronic data; and
said host web server broadcasts real-time to said plurality of remote computers the status of the cessation of said electronic data entry and the results thereof.

2. The method of claim 1, wherein said communication lines comprise telephonic or satellite or broadband communication lines, and the like; said communication lines further comprising of the means to transmit real-time broadcast signals.

3. The method of claim 1 whereby said remote plurality of computers further comprises an auction output device; said auction output device comprising the means whereby said remote plurality of computers view said real-time broadcast signals.

4. The method of claim 1 whereby said remote plurality of computers further comprises an auction input device; said auction input device comprising the means whereby said remote plurality of computers input real-time electronic bids.

5. A method of conducting a real-time interactive auction utilizing a computer network; said computer network comprising a remote broadcast location, host web server, an auction information server, an auction server, an absentee bid agent, an auctioneer and a plurality of remote computers and communication lines connecting said remote computers to said computer network; said method of auction comprising of the following steps:
said plurality of remote computers access a website on the world wide web;
said plurality of remote computers establish connectivity with said host web server by way of said website;
said plurality of remote computers register to qualify to participate in said method of auction by way of said website;
said host web server qualifies and grants said plurality of remote computers access to participate in said method of auction;
said host web server establishes real-time connectivity with said plurality of remote computers;
said host web server substantially simultaneously displays to said plurality of remote computers, real-time, live-stream broadcast signals;
said broadcast signals comprise varied electronic data;
said plurality of remote computers individually, successively and simultaneously input electronic data in response to said broadcast signals from said host web server;
said absentee bid agent individually, successively and simultaneously inputs electronic data in response to said broadcast signals from said host web server;
said auction server receives, validates and processes in a ranked order said electronic data originating from said plurality of remote computers;
said host web server simultaneously broadcasts real-time in a ranked order to all of said plurality of remote computers said electronic data originating from any one of said plurality of remote computers;
said host web server repeats steps “i” and “j” each time said host web server receives said electronic data from any of said plurality of remote computers;
said host web server determines when said electronic data originating from any one or all of said plurality of remote computers has ceased;
said auction server determines which of said plurality of remote computers sent the most recent submission of said electronic data; and
said host web server broadcasts real-time to said plurality of remote computers the status of the cessation of said electronic data entry and the results thereof.

6. The method of claim 5, wherein said communication lines comprise telephonic or satellite or broadband communication lines, and the like; said communication lines further comprising of the means to transmit real-time broadcast signals.

7. The method of claim 5 whereby said remote plurality of computers further comprises an auction output device; said auction output device comprising the means whereby said remote plurality of computers view said real-time broadcast signals.

8. The method of claim 5 whereby said remote plurality of computers further comprises an absentee bid agent; said absentee bid agent comprising the means whereby said absentee bid agent inputs real-time electronic bids.

9. The method of claim 1 wherein said computer network comprises several hyper text transport protocol servers with the means to facilitate said method of auction, said hyper text transport protocol servers cooperating with separate database computers, said database computers being accessible to at least one said hyper text transport protocol server to allow retrieval of information.

10. The method of claim 5 wherein said computer network comprises several hyper text transport protocol servers with the means to facilitate said method of auction, said hyper text transport protocol servers cooperating with separate database computers, said database computers being accessible to at least one said hyper text transport protocol server to allow retrieval of information.

11. The method of claim 1 wherein within said computer network exist software applications and electronic databases that collectively comprise the auction management system; said auction management system being further comprised of:
means whereby said plurality of remote computers interface with said broadcast signals from said host web server;
means whereby said host web server displays said electronic data contained therein to said plurality of remote computers' browsers;
means whereby said plurality of remote computers enter and participate in said method of auction;
means whereby said plurality of remote computers individually and successively and simultaneously enter said electronic data in response to said broadcast signals from said host computer;
means whereby said host web server receives said electronic data from each of said plurality of remote computers; and
means whereby said host web server broadcasts real-time said electronic data originating from any one of said plurality of remote computers to each of said plurality of remote computers.

12. The method of claim 5 wherein within said computer network exist software applications and electronic databases that collectively comprise the auction management system; said auction management system being further comprised of:
means whereby said plurality of remote computers interface with said broadcast signals from said host web server;
means whereby said host web server displays said electronic data contained therein to said plurality of remote computers' browsers;
means whereby said plurality of remote computers enter and participate in said method of auction;
means whereby said absentee bid agent enters and participates in said method of auction;
means whereby said plurality of remote computers individually and successively and simultaneously enter said electronic data in response to said broadcast signals from said host computer;
means whereby said absentee bid agent individually and successively and simultaneously enters said electronic data in response to said broadcast signals from said host computer;
means whereby said host web server receives said electronic data from each of said plurality of remote computers; and
means whereby said host web server broadcasts real-time said electronic data originating from any one of said plurality of remote computers to each of said plurality of remote computers.

13. The method of claim 1 comprising a site on the world wide web; said website being accessible by said plurality of remote computers for information regarding said method of auction; said website comprising:
information identifying a particular goods, service, security, commodity, or item available for auction;
electronic images of a particular goods, service, security, commodity, or item available for auction;
electronic descriptions of a particular goods, service, security, commodity, or item available for auction;
expert opinion regarding a particular goods, service, security, commodity, or item available for auction;
minimum starting bid of a particular goods, service, security, commodity, or item available for auction;
auction start time;
information on how to register as an interactive auction participant prior to the auction;
rules and regulations of the auction;
schedule of upcoming interactive auctions and a corresponding schedule of particular goods, services, commodities, or items available for auction; and an electronic auction catalogue.

14. The method of claim 5 comprising a site on the world wide web; said website being accessible by said plurality of remote computers for information regarding said method of auction; said website comprising:
information regarding said auctioneers; said information further comprising audio, visual, textual, and electronic data;
information identifying a particular goods, service, security, commodity, or item available for auction;
electronic images of a particular goods, service, security commodity, or item available for auction;
electronic descriptions of a particular goods, service, security, commodity, or item available for auction;
expert opinion regarding a particular goods, service, security, commodity, or item available for auction;
minimum starting bid of a particular goods, service, security, commodity, or item available for auction;
auction start time;
information on how to register as an interactive auction participant prior to the auction;
rules and regulations of the auction;
schedule of upcoming interactive auctions and a corresponding schedule of particular goods, services, commodities, or items available for auction; and an electronic auction catalogue.

15. The method of claim 1, comprising of means whereby said plurality of remote computers register to qualify to participate in said method of auction; said registration comprising an application on said website.

16. The method of claim 5, comprising of means whereby said plurality of remote computers register to qualify to participate in said method of auction; said registration comprising an application on said website.

17. The method of claim 16, whereby said registration comprises:
the registrant's name;
the registrant's address;
the registrant's phone number;
the registrant's electronic mail address;
the registrant's personal verification information, including but not limited to, government issued documents, biometric data, and personal information;
the registrant's qualifying financial information; and
an electronically signed acknowledgement.

18. The method of claim 5, comprising of means whereby said plurality of remote computers register to qualify to participate in said method of auction; said registration comprising an application on said website.

19. The system of claim 18, whereby said registration comprises:
the registrant's name;
the registrant's address;
the registrant's phone number;
the registrant's electronic mail address;
the registrant's personal verification information, including but not limited to, government issued documents, biometric data, and personal information;
the registrant's qualifying financial information; and
an electronically signed acknowledgement.

20. The method of claim 1 whereby said web server further comprises the means to receive said application from said registrant and to qualify said registrant for said method of auction; said qualification comprising an identification number and a password.

21. The method of claim 5 whereby said web server further comprises the means to receive said application from said registrant and to qualify said registrant for said method of auction; said qualification comprising an identification number and a password.

22. The method of claim 1 whereby said web server further comprises the means whereby said plurality of remote computers access said method of auction; said method of access comprising said password and said identification number.

23. The method of claim 5 whereby said web server further comprises the means whereby said absentee bid agent accesses said method of auction; said method of access comprising said password and said identification number.

24. The method of claim 1, whereby said method of auction comprises a real-time, live-stream broadcast to said plurality of remote computers; said broadcast further comprising said particular goods, services, securities, commodities, or items available for said method of auction.

25. The method of claim 5, whereby said method of auction comprises a real-time, live-stream broadcast to said plurality of remote computers; said broadcast further comprising said particular goods, services, securities, commodities, or items available for said method of auction.

26. The method of claim 1 wherein said method of auction comprises an electronic auctioneer.

27. The method of claim 1 wherein said method of auction comprises a live, human being auctioneer.

28. The method of claim 5 wherein said method of auction comprises an electronic auctioneer.

29. The method of claim 5 wherein said method of auction comprises a live, human being auctioneer.

30. The method of claim 1 being further comprised of the means whereby said electronic auctioneer solicits bids from said plurality of remote computers for said particular goods, service, security, commodity, or item available for said method of auction.

31. The method of claim 1 being further comprised of the means whereby said a live, human being auctioneer solicits bids from said plurality of remote computers for said particular goods, service, security, commodity, or item available for said method of auction.

32. The method of claim 5 being further comprised of the means whereby said electronic auctioneer solicits bids from said plurality of remote computers for said particular goods, service, security, commodity, or item available for said method of auction.

33. The method of claim 5 being further comprised of the means whereby said live, human-being auctioneer solicits bids from said plurality of remote computers for said particular goods, service, security, commodity, or item available for said method of auction.

34. The method of claim 1 being comprised of the means whereby said method of auction is translated in the respective language of said plurality of remote computers said method of auction is broadcast to.

35. The method of claim 5 being comprised of the means whereby said method of auction is translated in the respective language of said plurality of remote computers said method of auction is broadcast to.

36. The method of claim 1 being further comprised of said auction input device.

37. The method of claim 5 being further comprised of said auction output device.

38. The system of claim 36 further comprising the means whereby said plurality of remote computers submit said electronic data from said plurality of remote computers to said host web server using said auction input device; said electronic data being comprised of:
audio data;
video data;
visual data;
text data;
live-text data; and
biometric data.

39. The system of claim 37 further comprising the means whereby said plurality of remote computers submit said electronic data from said plurality of remote computers to said host web server using said auction input device; said electronic data being comprised of:
audio data;
video data;
visual data;
text data;
live-text data; and
biometric data.

40. The method of claim 38 being further comprised of the means whereby the submission of said electronic data is comprised of biometric data; said biometric data comprising a:
signature;
fingerprint;
handprint;
voice print; or
retina information.

41. The method of claim 39 being further comprised of the means whereby the submission of said electronic data is comprised of biometric data; said biometric data comprising a:
signature;
fingerprint;
handprint;
voice print; or
retina information.

42. The system of claim 36 being further comprised of a remote device that is not attached to said plurality of remote computers.

43. The system of claim 37 being further comprised of a remote device that is not attached to said plurality of remote computers.

44. The method of claim 5 whereby said host web server comprises the means whereby said plurality of remote computers submit an absentee bid record to said host web server.

45. The method of claim 44 being further comprised of the means wherein said absentee bid record further comprises:
a particular auction;
a particular auction item;
the maximum bid amount for said particular item;
increments of said maximum bid; and
said registration information.

46. The method of claim 5 being further comprised of the means whereby said host web server receives and records said absentee bid record and sends to said plurality of remote computers a confirmation of said absentee bid record.

47. The method of claim 5 being further comprised of the means whereby said absentee bid agent submits said absentee bid record on behalf of said plurality of remote computers.

48. The method of claim 5 whereby said absentee bid agent further comprises:
means whereby said auction bid agent operates separate and independent from said auction server and from said auctioneer;
means whereby said auction bid agent submits said absentee bid record to said method of auction;
means whereby said auction bid agent bids the minimum allowed bid;
means whereby said auction bid agent automatically increases said minimum allowed bid;
means whereby said auction bid agent automatically outbids other bidders until said maximum bid is reached; or
means whereby said auction bid agent automatically bids only the current prevailing bid, plus the said bid increment; and
means whereby said auction bid agent automatically notifies said plurality of remote computers of the results thereof with respect to said absentee bid record.

49. The method of claim 1 comprising the means whereby said host web server receives said electronic data input from said plurality of remote computers and submits to said electronic data input to said method of auction; said electronic data input comprising the bid.

50. The method of claim 5 comprising the means whereby said host web server receives said electronic data input from said plurality of remote computers and submits to said electronic data input to said method of auction; said electronic data input comprising the bid.

51. The system of claim 49 wherein said computer network further comprises software applications and electronic databases that collectively comprise the bid mechanics verification module; said bid mechanics verification module being further comprised of:
means whereby said auction server verifies said plurality of remote computer's identification number to verify the source of said bid;
means whereby said auction server verifies that said plurality of remote computer's identification number matches the existing registration record in said auction information database;
means whereby said auction server qualifies said plurality of remote computer's said bid as a validated bid;
means whereby said auction server ranks said plurality of remote computer's said validated bid in the order said validated bid was received;
means whereby said auction server registers said plurality of remote computer's said validated bid in the order said validated bid was received;
means whereby said auction server submits said validated bid to said method of auction;
means whereby said host web server broadcasts each of said validated bids to said plurality of remote computers in the order said validated bid were received;
means whereby said auction server continually repeats said bid mechanics process upon receipt of said bids from any of said plurality of remote computers;
means whereby said auction server determines when said electronic data input originating from any one or all of said plurality of remote computers has ceased; and
means whereby said auction server notifies said plurality of remote computers of the status of said cessation of said electronic data entry input and the results thereof.

52. The system of claim 50 wherein within said computer network exist software applications and electronic databases that collectively comprise the bid mechanics verification module; said bid mechanics verification module being further comprised of:
means whereby said auction server verifies said plurality of remote computer's identification number to verify the source of said bid;
means whereby said auction server verifies that said plurality of remote computer's identification number matches the existing registration record in said auction information database;
means whereby said auction server qualifies said plurality of remote computer's said bid as a validated bid;
means whereby said auction server ranks said plurality of remote computer's said validated bid in the order said validated bid was received;
means whereby said auction server registers said plurality of remote computer's said validated bid in the order said validated bid was received;
means whereby said auction server submits said validated bid to said method of auction;
means whereby said host web server broadcasts each of said validated bids to said plurality of remote computers in the order said validated bid were received;
means whereby said auction server continually repeats said bid mechanics process upon receipt of said bids from any of said plurality of remote computers;
means whereby said auction server determines when said electronic data input originating from any one or all of said plurality of remote computers has ceased; and
means whereby said auction server notifies said plurality of remote computers of the status of said cessation of said electronic data entry input and the results thereof.

53. The method of claim 1 further comprising the following information which is simultaneously broadcast to said remote plurality of computers; said information being simultaneously displayed on the browsers of said remote plurality of computers:
electronic description of the current auction item;
minimum starting bid;
current highest bid;
bid history; said bid history comprising of the previous bids;
source of said bid as represented by said identification number; and
the auction winner.

54. The method of claim 5 further comprising the following information which is simultaneously broadcast to said remote plurality of computers; said information being simultaneously displayed on the browsers of said remote plurality of computers:
electronic description of the current auction item;
minimum starting bid;
current highest bid;
bid history; said bid history comprising of the previous bids;
source of said bid as represented by said identification number; and
the auction winner.

55. The method of claim 1 whereby said host web server comprises an auction merchandise database, said merchandise database being comprised of the available goods, services, securities, commodities. or items available for said method of auction and a unique identifying reference number or code for said particular good, service, security, commodity or item available for said method of auction.

56. The system of claim 55 further comprising of an electronic catalogue; said electronic catalogue comprising:
said unique identifying reference number or code for said particular good, service, security, commodity or item available for said method of auction;
a description of said particular good, service, security, commodity or item available for said method of auction;
an image of said particular good, service, security, commodity or item available for said method of auction;
the minimum starting bid for said particular good, service, security, commodity or item available for said method of auction;
the auction start time and date for said particular good, service, security, commodity or item available for said method of auction; and
expert opinion regarding said particular good, service, security, commodity or item available for said method of auction.

57. The method of claim 5 whereby said host web server comprises an auction merchandise database, said merchandise database being comprised of the available goods, services, securities, commodities or items available for said method of auction and a unique identifying reference number or code for said particular good, service, security, commodity or item available for said method of auction.

58. The system of claim 57 further comprising of said electronic catalogue; said electronic catalogue comprising:
said unique identifying reference number or code for said particular good, service, security, commodity or item available for said method of auction;
a description of said particular good, service, security, commodity or item available for said method of auction;
an image of said particular good, service, security, commodity or item available for said method of auction;
the minimum starting bid for said particular good, service, security, commodity or item available for said method of auction;
the auction start time and date for said particular good, service, security, commodity or item available for said method of auction; and
expert opinion regarding said particular good, service, security, commodity or item available for said method of auction.

59. The method of claim 1 whereby the items available for auction are comprised of submissions of items for auction from said remote plurality of computers.

60. The system of claim 59 further comprising the following steps:
said plurality of remote computers access said website;
said plurality of remote computers select an upcoming participant-item auction;
said plurality of remote computers completes an auction item submission form, said submission form in part comprising of a description, an electronic image and minimum starting bid of said item for auction;
said plurality of remote computers submits said auction item submission form to said host web server;
said host web server confirms receipt of said auction item submission form;
said host web server confirms that said item for auction complies with said rules and regulations for said method of auction;
said host web server accepts said item for auction and notifies said plurality of remote computers; and
said host web server posts said item for auction in said electronic catalogue that corresponds to said participant-item auction.

61. The method of claim 5 whereby the items available for auction are comprised of submissions of items for auction from said remote plurality of computers.

62. The system of claim 61 further comprising the following steps:
said plurality of remote computers access said website;
said plurality of remote computers select an upcoming participant-item auction;
said plurality of remote computers completes an auction item submission form, said submission form in part comprising of a description, an electronic image and minimum starting bid of said item for auction;
said plurality of remote computers submits said auction item submission form to said host web server;
said host web server confirms receipt of said auction item submission form;
said host web server confirms that said item for auction complies with said rules and regulations for said method of auction;
said host web server accepts said item for auction and notifies said plurality of remote computers; and
said host web server posts said item for auction in said electronic catalogue that corresponds to said participant-item auction.

63. The method of claim 1 comprising of the means whereby said host web server confirms to said auction winner the purchase of said particular auction item; the prevailing bid price and the terms and conditions thereof.

64. The method of claim 5 comprising of the means whereby said host web server confirms to said auction winner the purchase of said particular auction item; the prevailing bid price and the terms and conditions thereof.

65. The method of claim 1 further comprising the means whereby said host web server processes financial authorization for automated payment of said auction item.

66. The system of claim 65 further comprising the means whereby said host web server
retrieves from said auction server database winning bid records whereby said identification number indicates said winning bid record;
matches said winning bid record with said plurality of remote computers' auction registration account;
charges said registration account said bid amount stored in said winning bid record; and
notifies and sends confirmation of the financial transaction to said plurality of remote computers via electronic mail.

67. The method of claim 5 further comprising the means whereby said host web server processes financial authorization for automated payment of said auction item.

68. The system of claim 67 further comprising the means whereby said host web server retrieves from said auction server database winning bid records whereby said identification number indicates said winning bid record;
matches said winning bid record with said plurality of remote computers' auction registration account;
charges said registration account said bid amount stored in said winning bid record; and
notifies and sends confirmation of the financial transaction to said plurality of remote computers via electronic mail.
